(19) United States
(12) Patent Application Publication
(10) Pub. No.: US 2025/0035482 A1
(43) Pub. Date: Jan. 30, 2025

(54) A SYSTEM AND METHOD FOR ESTIMATING A MASS OF A VEHICLE

(71) Applicant: University of Pretoria, Pretoria (ZA)

(72) Inventor: Riaan MEESER, Pretoria (ZA)

(21) Appl. No.: 18/716,363

(22) PCT Filed: Nov. 23, 2022
(86) PCT No.: PCT/IB2022/061330

§ 371 Date: Jun. 4, 2024

(30) Foreign Application Priority Data
Dec. 6, 2021 (ZA) 2021/09992

(51) Int. Cl. G01G 19/08

(52) U.S. Cl. CPC G01G 19/086

(57) ABSTRACT

A system is provided for estimating a mass of a vehicle. The system includes a torsion sensor (e.g., provided by strain gauges) provided on at least a drive axle of the vehicle and configured to measure torsion in the drive axle between a drive input and a load of the drive axle. The system also includes at least one speed sensor configured to measure a speed of the drive axle and at least one sensor configured to measure or derive an inclination. A control module which is communicatively coupled to the torsion sensor, the speed sensor, and the sensor to measure or derive the inclination, thereby to receive signals from the sensors indicative of the characteristics they measure. The control module is configured to estimate the mass of the vehicle based on the signals from the sensors by solving an equation of motion based on the received signals.

### FIELD OF INVENTION

This invention provides a system and method for estimating a mass of a vehicle in real-time using sensor-based readings.

### BACKGROUND OF INVENTION

It has become essential to reduce the consumption of fossil fuels to reduce harmful emissions and move to a cleaner and more sustainable future. One technology that has been implemented to perform this reduction in fossil fuel consumption is the application of hybrid and battery technologies to vehicles. This technology makes use of electric systems and controls to aid the fossil fuel power trains of vehicles and allow them to run more efficiently. For a hybrid or electric vehicle control system, it is of great benefit to know the energy requirements for the vehicle to complete its route, and proper optimisation strategies rely heavily on accurate energy requirement parameters, like the vehicle mass.

This invention is concerned with on-vehicle mass measurement (in contrast with, for example, external weigh stations). The Applicant is aware that vehicle mass may be measured by load sensors or load cells provided at axles of the vehicle. This can provide accurate measurements. However, it has the drawback that each axle of the vehicle would require a load sensor, which can become more expensive and more complex the more axles a vehicle has. Further, if a trailer is hitched to the vehicle, the trailer may then be unmeasured if its axle(s) has no load sensor (and this could even interfere with the measurements at the vehicle's axles).

The Applicant wishes to measure or estimate a vehicle's mass without load sensors; the applicant desires a system and method that is able to estimate not only the mass of a vehicle but also include the mass of trailers, if added, without the use of wheel load sensors for each axle.

### SUMMARY OF INVENTION

Accordingly, the invention provides a system for estimating a mass of a vehicle, the system including:
a torsion sensor provided on at least a drive axle of the vehicle, wherein the torsion sensor is configured to measure torsion in the drive axle between a drive input and a load of the drive axle;
at least one speed sensor configured to measure a speed of the drive axle or of the vehicle;
at least one sensor to measure or derive an inclination of the vehicle; and
a control module which is:
   communicatively coupled to the torsion sensor, the speed sensor, and the sensor to measure or derive the inclination, thereby to receive signals from the sensors indicative of the characteristics they measure; and
   configured to estimate the mass of the vehicle based on the signals from the sensors by solving an equation of motion based on the received signals.

The term vehicle may include a standalone vehicle and may include a draught vehicle coupled to a trailer or other drawn vehicle.

The torsion sensor may be provided only on the drive axle (or axles) of the vehicle. Passive axles (e.g., non-driven axles or axles of trailers) may not have a torsion sensor provided thereon.

The torsion sensor may be embodied by a plurality of strain gauges. The strain gauges may be coupled together to form the torsion sensor (which can also be considered a torsional load cell).

The strain gauges may be provided at various locations on the drive axle. The strain gauges may be provided at a front and a rear of the drive axle and front and rear locations may be mirrored. Providing them at the front and at the back of the drive axle may allow them to be wired such that bending moments in the forward and backward direction are cancelled out.

The strain gauges may be placed on a horizontal centreline of the drive axle; this may mean that they will not see a bending moment due to supporting a stationary weight of the vehicle.

There may be, for example, eight strain gauges with two at a front left, two at a front right, two at a rear left, and two at a rear right of the drive axle.

In one vehicle type, the drive axle may be a live axle supported on a suspension at ends of the axle by means of leaf springs; accordingly, torque transfer from differential to wheel may be measured by the strain gauges as a reaction force of the centrepiece of the differential relative to the suspension.

The strain gauges may be connected to an ADC (Analogue-Digital Convertor). The strain gauges may be interconnected in a Wheatstone bridge configuration.

The speed sensor may be provided by an encoder (e.g., an optical encoder) coupled to a rotary part of the vehicle, like a wheel. The optical encoder may register rotational wheel displacement which is indicative of vehicle speed and/or displacement. Instead, or in addition, the speed sensor may be provided by standard equipment on the vehicle, like a speedometer/odometer, or a connection to an ECU (Electronic Control Unit) of the vehicle, or by a GPS module (either already present in the vehicle or provided specifically to work with the system for estimating the mass of the vehicle).

The sensor to measure or derive an inclination may include a barometric pressure sensor. The barometric pressure sensor may be configured to measure barometric altitude. The control module may be configured to determine barometric altitude as a function of distance thereby to provide an estimation for an incline of a section of travel or road.

The control module may include preconfigured or preconfigurable constants for use in the equation of motion, e.g., a drag coefficient for the vehicle to estimate drag or aerodynamic resistance of the vehicle.

The equation of motion may be a force-balance equation. The force-balance equation may include, for a vehicle travelling on an incline, propulsion force, aerodynamic resistance, rolling resistance, acceleration, and incline forces. A sum of forces balance may be performed to solve for the mass of the vehicle, with all of the other variables being measured, estimated, known, or predefined.

The invention extends to a method of estimating a mass of a vehicle, the method including:
measuring, by a torsion sensor provided on at least a drive axle of the vehicle, torsion in the drive axle between a drive input and a load of the drive axle;
measuring, by at least one speed sensor, a speed of the drive axle or of the vehicle;
measuring or deriving, by at least one sensor, an inclination of the vehicle; and
estimating, by a control module which is communicatively coupled to the torsion sensor, the speed sensor, and the sensor to measure or derive the inclination thereby to receive signals from the sensors indicative of the characteristics they measure, the mass of the vehicle based on the signals from the sensors by solving an equation of motion.

The method may include:
estimating the mass of the vehicle;
comparing the estimation with known quantities (e.g., a pre-measured or reference mass of the vehicle); and
adjusting constants or criteria of the control module based on the comparison, thereby to tune the estimation.

This tuning may be based on iterative estimation and measurements.

### BRIEF DESCRIPTION OF DRAWINGS

The invention will now be further described, by way of example, with reference to the accompanying diagrammatic drawings.

In the drawings:

FIG. 1 shows a PRIOR ART schematic free body diagram of an inclined vehicle;

FIG. 2 shows a photo of a test vehicle, having a system for estimating mass in accordance with the invention applied thereto, on a weighbridge;

FIG. 3 shows a graph of estimated barometric altitude produced by a barometric sensor forming part of the system of FIG. 2;

FIG. 4 shows a schematic view of a drive axle with strain gauges, forming part of the system of FIG. 2;

FIG. 5 shows a photo of an axle of the vehicle of FIG. 2 with strain gauges of FIG. 4 attached thereto;

FIG. 6 shows a diagram of a wiring arrangement of the strain gauges of FIG. 4;

FIG. 7 shows a graph of axle torque while accelerating through gears measured by the strain gauges of FIG. 4;

FIG. 8 shows a circuit diagram of the system of FIG. 2, including the control module and various sensors;

FIG. 9 shows an octave program schematic for mass estimation of the system of FIG. 8;

FIG. 10 shows a photo of the test vehicle of FIG. 2 with a trailer;

FIG. 11 shows a photo of an alternative larger trailer, with a load, which may be used with the setup of FIG. 10;

FIG. 12 shows a graph of raw mass estimation derived from the sensors of FIG. 8;

FIG. 13 shows a zoomed-in graph of FIG. 12;

FIG. 14 shows a graph of test data for calculated mass vs power for the system of FIG. 8;

FIG. 15 shows a graph of test data for calculated mass vs velocity for the system of FIG. 8;

FIG. 16 shows a graph of test data for calculated mass vs acceleration for the system of FIG. 8;

FIGS. 17-19 show graphs having different denominator vs mass axes for the system of FIG. 8; and

FIG. 20 shows a graph of estimated mass for the system of FIG. 8.

### DETAILED DESCRIPTION OF EXAMPLE EMBODIMENT

The following description of an example embodiment of the invention is provided as an enabling teaching of the invention. Those skilled in the relevant art will recognise that changes can be made to the example embodiment described, while still attaining the beneficial results of the present invention. It will also be apparent that some of the desired benefits of the present invention can be attained by selecting some of the features of the example embodiment without utilising other features. Accordingly, those skilled in the art will recognise that modifications and adaptations to the example embodiment are possible and can even be desirable in certain circumstances and are a part of the present invention. Thus, the following description of the example embodiment is provided as illustrative of the principles of the present invention and not a limitation thereof.

In this example embodiment, a system for estimating a mass of a vehicle, in accordance with the invention, comprises a plurality of strain gauges which together act as a torsion sensor, at least one sensor (e.g., an optical rotation sensor) configured as a speed sensor to measure a speed of the drive axle or of the vehicle, and a barometric sensor used to derive an inclination of the vehicle. The various sensors are connected to one or more electronic modules (collectively referred to as a control module) which uses readings from the sensors to estimate a mass of the vehicle.

### Theory

Initially, some theory behind the system for estimating a mass of a vehicle (as defined above) will be disclosed. Some of this theory may be considered prior art. However, the theory when used in conjunction with the system may be inventive.

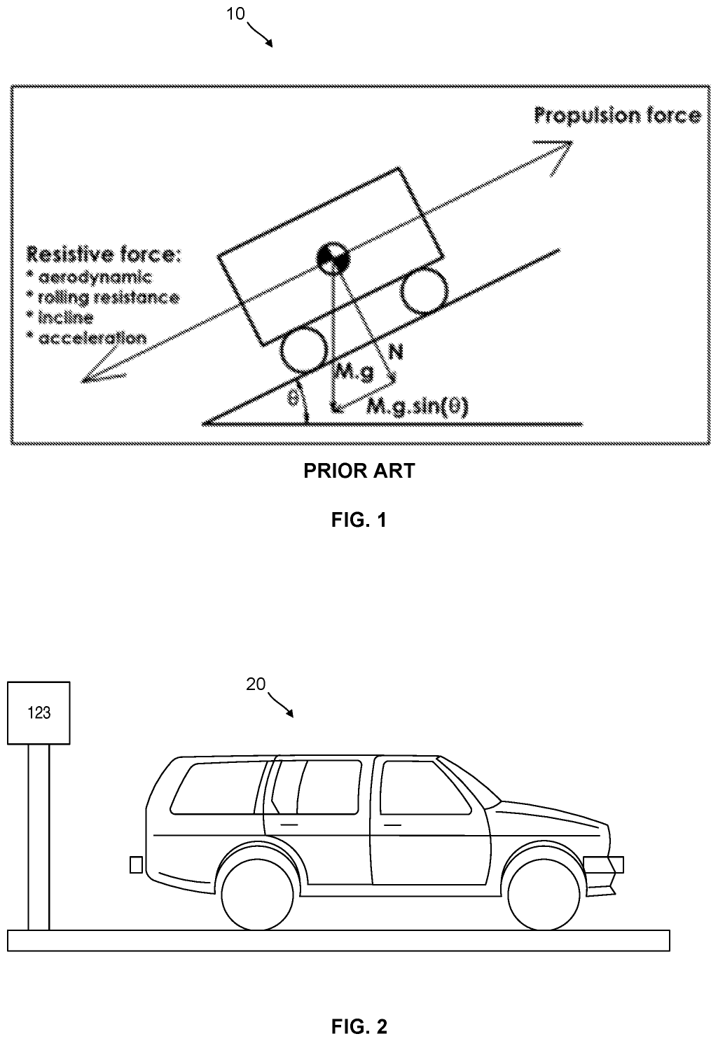

FIG. 1 illustrates a free body diagram 10 showing external forces applicable to the vehicle. For a vehicle travelling on an incline, the force balance on the vehicle comprises the propulsion force, aerodynamic resistance, rolling resistance, acceleration, and incline forces. A sum of forces balance is performed to solve the mass estimation problem.

The various forces are as follows:
Acceleration force: The wheel rotational displacement is logged as a function of time. The control module responsible for calculating the speed of the vehicle measures the amount of microseconds between two consecutive pulses on the wheel's rotary optical encoder, and from this an instantaneous velocity can be obtained. By calculating the change in velocity over a known time period one is able to find the acceleration that the vehicle experienced during that time period. Determining the acceleration in this way may provide more stable values than what an accelerometer is able to give as an accelerometer is also susceptible to vehicular vibrations. The force generated by means of accelerating the vehicle of mass M is then determined by Newton's second law, Eq. 1:

$${F}_{a c c e l e r a t i o n} = M . acce l e r a t i o n \qquad Eq . l$$

Aerodynamic forces: Aerodynamic forces are modelled as a function of vehicle geometry, size, air density and velocity. The general aerodynamic force equation Eq. 2 is applied to the model with initial estimates for the vehicle used for testing purposes obtained from online sources. These initial estimates are then calibrated using the results obtained from tests, as the vehicle may have a slightly modified outside geometry from the standard one described in the auto data sheet.

$${F}_{a e r o} = 0.5 \times ρ {C}_{d} {A}_{f} {V}^{2} \qquad Eq . 2$$

A difficult phenomenon to account for in aerodynamic loading is wind loading, which changes the effective velocity and angle at which the vehicle passes through the air. This is assumed to be a small portion of the overall effect as the geographic location of the testing is not in an extremely windy zone, and thus the effect of wind is neglected. To evaluate wind speed sensitivity a simulation was run with a constant offset in the forward velocity for the aerodynamic drag equation of 3.6 m/s. During this simulation, a mass error of 10% is noted. This shows that the mass estimation algorithm is sensitive to variance in this parameter value. Measuring the true wind speed can be done by means of a wind speed meter mounted on the vehicle. This was however not done for this project as mounting of the sensor would involve extensive testing to determine the correct placement to account for aerodynamic effects. The 3.6 m/s offset simulation assumed the vehicle constantly experiences a wind force opposing the direction of movement, which would not be the real-world case.

Rolling resistance: The resistance to motion as a result of the friction of a tire rolling over a road can be presented in several ways. The first and most simple way is by simply multiplying the normal force on the road by a constant factor, termed the rolling resistance coefficient. This is the most elementary form of the rolling resistance equation. For vehicles travelling at a relatively low and constant velocity, this approach works well. It can be represented by the following equation:

$${F}_{r o l l} = {C}_{rr} N \qquad Eq . 3$$

Where Fᵣₒₗₗ is a force that always opposes the direction of motion, Cᵣᵣ is a constant factor, usually between 0.012-0.015 for vehicle tires on tar surfaces and N is the normal force of the vehicle on the road. It should be noted that the experiment that was performed in this study was done using a road vehicle, so this factor should be updated accordingly for different vehicle and running surface types. At low speeds, a more accurate version of this equation incorporates a linear velocity dependent term.

$${C}_{rr} = 0.01 + ( 1 + V {/}_{100} ) \qquad Eq . 4$$

Where V is the velocity in mph. Variations of this linear velocity dependent rolling resistance coefficient also exist but work in the same manner where a constant term is added to a term multiplied by the velocity, some models even account for the type of tyre construction, like radial or bias. Over even broader speed ranges the rolling resistance factor rises in a manner that is more closely approximated by a quadratic relationship with respect to velocity. The Institute of Technology in Stuttgart developed such an equation. The factors used in their equation are then also pressure dependent, making it very hard to implement on a vehicle when the exact details of all their coefficients are not known. Due to the moderate speed levels that the test vehicle will experience and additional complexity of the non-linear equations only the constant and linearly varying rolling resistance functions will be applied and updated if proven to not yield satisfactory results.
Incline force: A barometric pressure sensor combined with an odometer may be capable of accurately representing the topographic characteristic of a route travelled, with the typical relative error of the sensor being less than 1 meter, resulting in an incline error over a 100-meter distance of less than 1°. By taking the derivative of the topographic plot with respect to distance, one is able to obtain the incline angle data for a route travelled. With the incline angle known throughout the route, it would be possible to determine the incline component of the forces imposed on the vehicle, as indicated in FIG. 1. When the vehicle is travelling up an incline, the incline forces act to reduce the velocity of the vehicle, and when travelling downhill the incline force direction switches around such that the decline force works in the same direction as the propulsion force wanting to increase the vehicle velocity. The incline force is calculated by taking the mass component parallel to the direction of travel for a vehicle located on an incline, thus Eq. 5 gives the incline force:

$${F}_{i n c l i n e} = M . g . s i n ( θ ) \qquad Eq . 5$$

3.1.5 Propulsion force: A proposal was made to measure the torque on the rear axle of the vehicle using strain gauges. The torque values obtained from the calibrated strain gauges will give repeatable and stable results with minimal noise. With the torque easily and accurately directly measured by means of strain gauges, one is able simply to divide the axle torque by the effective wheel radius to find the effective forward propulsion force applied by the vehicle drive train, like shown in Eq. 6.

$${F}_{propulsion} = \frac{{T}_{axle}}{wheel radius} \qquad Eq . 6$$

3.1.6 Braking force: To obtain an accurate model of the braking force of a vehicle may be very difficult, as factors including brake bias (which is load dependent for many commercial vehicles), brake fluid pressure, temperatures, velocity, the type of brakes on each wheel (front disc, rear drum), brake wear, and potentially other influences all have a drastic effect on the velocity retardation. The approach followed was simply to neglect calculations of vehicle mass whilst the brake pedal is pressed, as this is for a small fraction of the total travelling time. A pressure transducer was installed into the right rear wheel's brake line and the output voltage of the transducer was measured using an analogue pin on the control module. If the voltage reached a certain threshold value (exceeded a pre-set pressure value), the control module simply paused until the brake pressure is relieved. This pause/discontinuity does however give an error in the mass estimation results, as the vehicle velocity has a discontinuity which causes the program to assume the abrupt change in velocity was due to excessive mass, usually a ridiculously high value, to the order of millions of kilograms. These intermittent excessive values had to be discarded by the mass estimation algorithm.

Now that all the forces acting on the system are characterised, it would be possible to implement a force balance equation and solve for the only unknown, the vehicle mass. This is performed as follows:

$${F}_{propulsion} - {F}_{r o l l} - {F}_{a e r o} - {F}_{i n c l i n e} = {F}_{a c c e l e r a t i o n} \qquad Eq . 7$$

$$\frac{{T}_{a x l e}}{wheel radius} - {C}_{r r} . g . MASS - \frac{1}{2} ρ {C}_{d} {A}_{f} {V}^{2} - \qquad Eq . 8$$

$$MASS . g . sin ( θ ) = MASS ( acceleration )$$

$$MASS = \frac{( \frac{{T}_{axle}}{wheel radius} - \frac{1}{2} ρ {C}_{d} {A}_{f} {V}^{2} )}{( acce l e r a t ion + {C}_{r r} . g + g . sin ( θ ) )} \qquad Eq . 9$$

where:
Tₐₓₗₑ=Torque on axle measured by strain gauges, Nm
wheel radius=0.39 m (235/85R16 tyre)
ρ=Air density determined from barometric pressure, kg/m³
Ca=Drag coefficient, 0.4 (from vehicle datasheet)
Ar=Frontal area of vehicle, 2.33 m² (from vehicle datasheet)
V=Vehicle velocity from odometer sensor, m/s
acceleration=determined from change in velocity, m/s²
Cᵣᵣ=Rolling resistance factor, speed dependent (more accurate, option applied), typically between 0.012 and 0.015 for radial rubber tyres on tarmac=0.013 (1+V/42) {found by experimentation to yield best fit to data}
θ=Incline angle, radians

This equation may pose two risks, namely:
(1) If the propulsion force equals the aerodynamic drag force the numerator in Eq. 9 approaches zero, yielding zero mass calculated.
(2) Also, if the sum of the acceleration, the rolling resistance term and the incline term approaches zero, the denominator causes the mass value to approach infinity (±). Eq. 9 still holds true during these cases, but the inaccuracy of the sensor data causes the massive error. This needs to be carefully accounted for during the mass estimation calculations.

### Implementation

The test vehicle used was an Isuzu Frontier. This vehicle was instrumented with sensors to facilitate mass estimation. FIG. 2 shows the test vehicle 20 on a weighing bridge. The vehicle 20 had a mass of 2,090 kg with a full fuel tank, no payload, and no driver. The accuracy of the weigh bridge was stated as within 20 kg, which translates to 1% of the vehicle mass. A laptop was used together with two Arduino prototyping boards to facilitate the data recording of the sensor output values.

An encoder (e.g., an optical encoder) was fitted to a right rear wheel of the test vehicle 20 so that the rotational displacement of the wheel could be accurately determined. From the rotational displacement, the linear travel distance can be obtained by scaling the rotational displacement by the wheel radius. The main hardware for the optical encoder consists of an infrared LED and an infrared photo diode which oppose each other. A ridge is added on the outside of the brake drum, which is used to obstruct the infrared light beam, causing a change in voltage on the optical encoder and allowing the rotational displacement to be counted in discrete increments by the Arduino board forming part of the control module.

Notable point to remember is that wheel spinning will induce an error in the odometer reading if it is installed on one of the drive wheels, so care should be taken in the initial testing to minimise wheel spin, or to place the encoder on a non-drive wheel. Using a wheel to measure the displacement instead of the propeller shaft does induce small errors when the vehicle is travelling around corners, but this effect was neglected for the purpose of this study as the radius of roads are generally quite large compared to the width of the vehicle.

A GPS coordinate logger was used as a reference to compare with the optical trigger odometer values. From the test performed, the GPS data and the calibrated odometer data match extremely well. By the end of a 20 km route, there is an odometer difference of 60 m as compared to the GPS and online map information, yielding an odometer error of only 0.3%. This verifies the usability of the proposed optical encoder.

A way of obtaining the incline characteristics of the driven road is required. One method to obtain altitude is to use a barometric pressure sensor and, from the air pressure, one can determine an estimate for the altitude, from which the incline data can be derived if used together with an odometer. In an attempt to save cost, an inexpensive open-source sensor board was implemented, namely the GY87 which consists of a BMP085 barometric pressure sensor, a MPU6050 3-axis accelerometer (a 3-axis gyro), and a HMC5883L 3-axis magnetometer.

From a datasheet of the components, the “ultra-high resolution” mode is capable of measuring a 0.25 m altitude change, with the RMS noise of the signal being able to go down to 0.1 m, the resolution of the output data is 0.01 hPa (<0.1 m at sea level) (Sensortec, 2009). An initial test was performed by applying a change in altitude and determining the barometric altitude from the change in measured pressure. The pressure reading is converted to an effective altitude by means of the International barometric formula, Eq. 10, where P is the measured pressure and P₀ is the pressure at sea level. In this equation, a pressure change of 1 hPa equates to a change in altitude of 8.43 m at sea level.

$$Altitude = 44330 * ( 1 - {( \frac{P}{{P}_{0}} )}^{\frac{1}{5.255}} ) \qquad Eq . 10$$

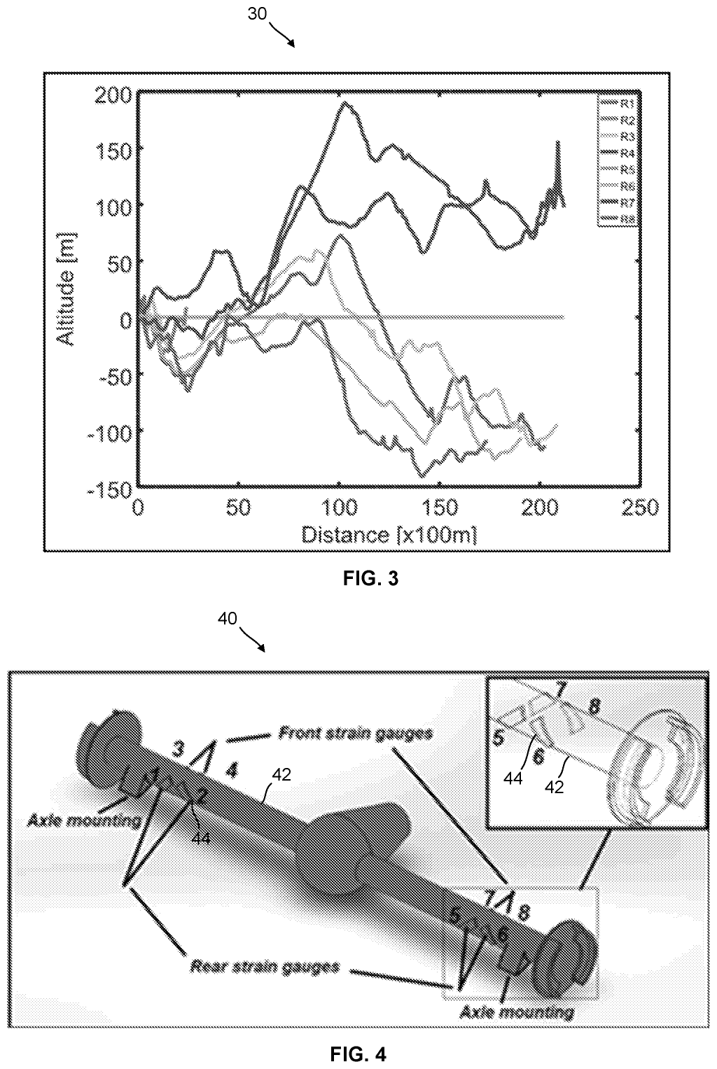

For the gathering of initial test data, the sensor was moved up and down in a building by means of riding the elevator, starting on floor 9, riding up to floor 15, down to floor 3 and then back up to floor 9. The raw data has a noise range of around 2.5 m, with the filtered data having a noise range of 0.4 m. Once calibrated, the barometric sensor was used to plot altitude for various routes, as illustrated in topographical plot 30 of FIG. 3, which shows eight tested routes.

Tests showed that an altitude drift due to weather can however cause a change in barometric altitude of up to 0.5 m in one minute. This does deteriorate the accuracy of the incline estimation. Even with the drift of 0.5 m and noise amplitude of 0.2 m it will still yield incline estimations within 0.4° over a 100 m distance. It can thus be assumed that the barometric altitude is usable as means to determine the incline of a section of road. It should be noted that this sensor's minimum detectable height does place a limitation on the shortest distance increment for which it can be used effectively.

Strain gauges (specifically, eight strain gauges) were applied to the drive axle of a live axle motor vehicle for driving torque measurement. The eight strain gauges were placed four at the front of the axle and four at the back of the axle, on the centreline of the axle. Placing them on the centreline means that they will not see a bending moment due to the vehicle weight. Placing them in front and at the back of the axle allows to wire them such that bending moment in the forward and backward direction is cancelled out as well. Because the vehicle uses a live axle that is supported on the suspension at the ends of the axle by means of leaf springs it means that the torque transfer from the differential to the wheel will be measured by these strain gauges as a reaction force of the centrepiece of the differential will torque against the suspension.

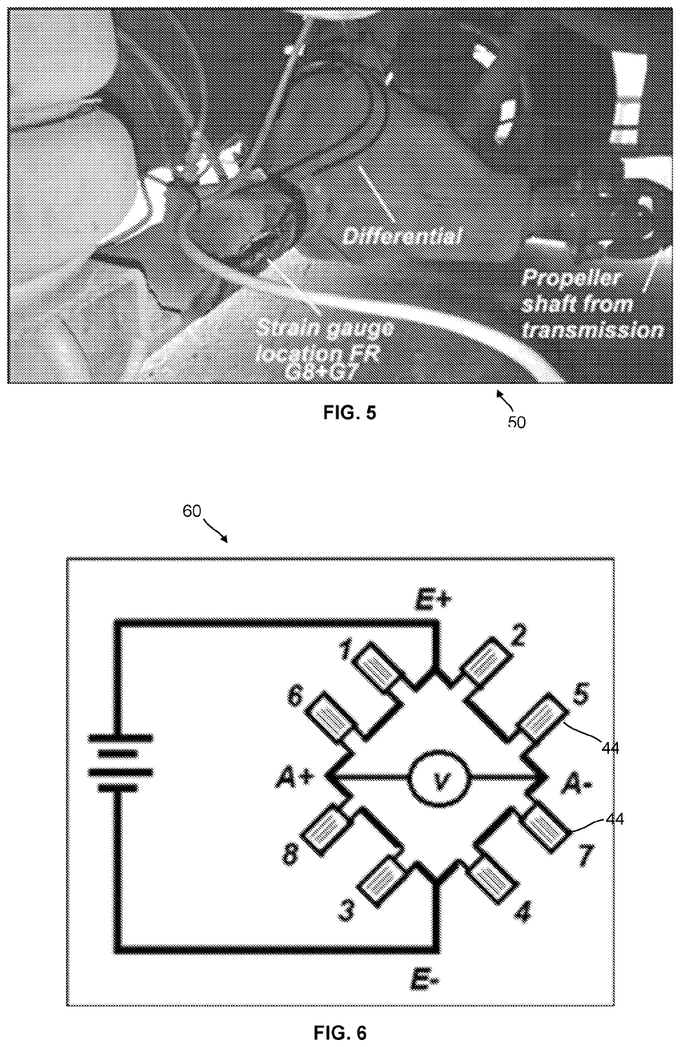

FIGS. 4-6 illustrate the arrangement 40 of strain gauges 44 on the axle 42 of the vehicle 20. There are eight strain gauges 404 labelled from 1 to 8. The strain from these eight strain gauges 44 is measured with a 24-Bit HX711 analogue to digital converter (forming part of the control module). The strain gauges 44 effectively form a torsional load cell which was given an initial calibration by applying a torque to the differential with a hand-held torque wrench. A photo 50 of the experimental setup is illustrated in FIG. 5 and a Wheatstone interconnection 60 of the strain gauges 44 is illustrated in FIG. 6. The torque was applied through knuckle joints so that no vertical forces/torques were applied to the tube of the axle 42 by the torque wrench during calibration.

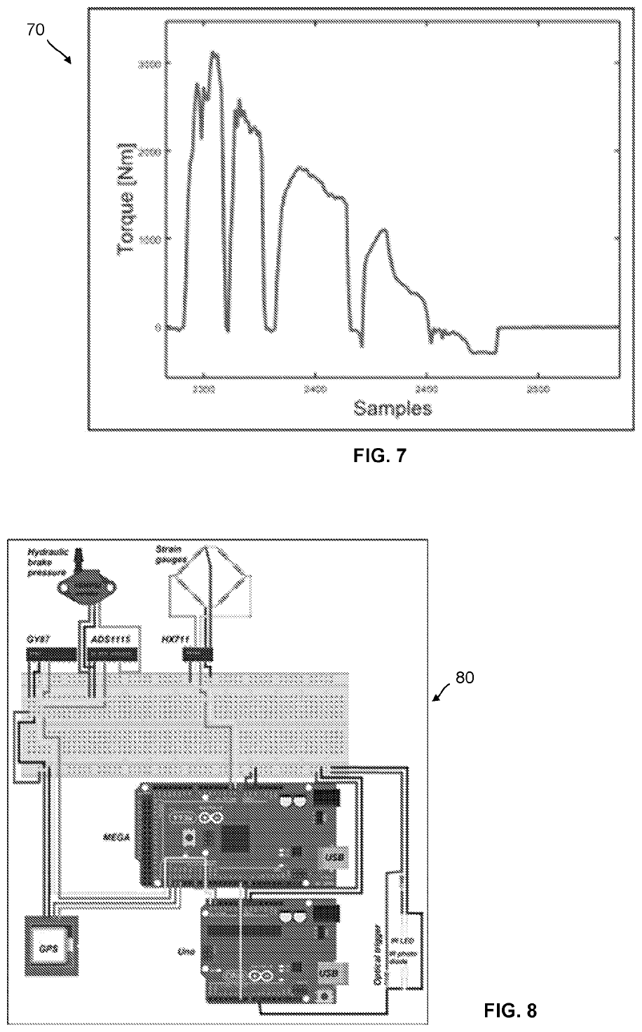

FIG. 7 shows a graph 70 of an axle torque result obtained when accelerating from a standstill from first gear to fourth gear. The driving torque measured on the rear axle yields stable and sensible results and can now be used in the mass estimation strategy.

To facilitate pausing the program during brake events, the brake pressure was measured using an analogue pressure transducer. The signal from the pressure transducer was processed using a 16-Bit ADS1115 analogue to digital converter. It will now be possible to determine when the brakes are applied if the pressure in the brake system was found to exceed some minimum threshold value, and the mass estimation program can then be paused until the pressure drops below a threshold value. The pressure sensor used is an analogue sensor that outputs a voltage from 0.5 v to 4.5 v for a pressure of 0 MPa to 6.9 MPa (1,000 PSI) respectively. Instead, or in addition, a simple connection to a brake light signal could be used to obtain an indication (even just a binary indication) of whether and/or how much the brakes are engaged.

FIG. 8 shows a schematic layout 80 of all the sensing and recording components used for mass estimation comprising the system in accordance with the invention. The Arduino Mega board is the master board (and forms the heart of the control module) that streams the data to the laptop for processing. The Arduino Uno board counts the optical encoder pulses to function as an odometer. The HX711 board is the 24 bit ADC for the axle torsional load cell. The ADS1115 is the ADC for the brake pressure. The GY87 contains the barometric pressure sensor for altitude estimation and the GPS is used as a reference to calibrate the optical trigger and verify the barometric data.

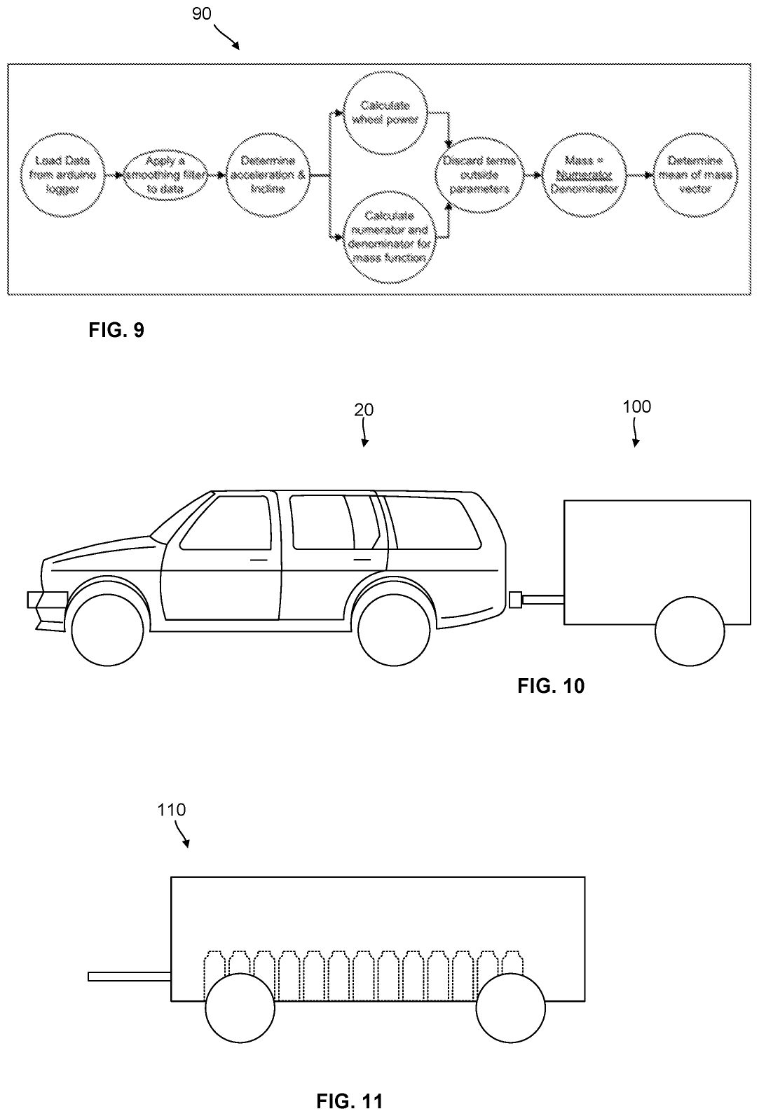

A schematic diagram 90 showing the calculation sequence for determining the vehicle mass is shown in FIG. 9. An advantage of this method is that it can be run post-test or updated in real-time, as the mean value will simply be updated continuously if run in real-time. The smoothing filter that is applied reduces the errors in mass estimation by reducing higher frequency variations in the sampled data.

An approach followed in this example is a novel way of determining vehicle weight by means of a torsional load cell mounted on or around the differential. An advantage of this approach is that it is not sensitive to weight distribution on the vehicle and may even work to estimate the combined mass of the vehicle and a trailer. Various parameters from the sensors were recorded at a frequency of 5 Hz, which was deemed high enough to pick up all the vehicle's dynamic movements but low enough to not generate excessive data.

For all the tests performed, the fuel mass was estimated by taking the average fuel consumption for the vehicle and the trip odometer reading to estimate the fuel amount used and subtracting the mass of that fuel from the vehicle gross mass.

Several driving tests were conducted with varying payloads placed in the vehicle 20. Tests were also performed with the vehicle 20 towing a small trailer laden with 75×5 litre (5 kg) water bottles. The small trailer had an empty mass of 230 kg determined by using a scale. The water bottles were each weighed and filled to within 1% of 5 kg using a digital scale.

The vehicle 20 and small trailer 100 are shown in FIG. 10. A larger trailer 110 (see FIG. 11) was also used to test the system for larger gross combined masses. The larger trailer 110 was towed in both empty and laden form. In FIG. 11 the trailer 110 is laden with 90×5 kg water bottles. It should be noted however that the larger trailer 110 increases the frontal area, which affects the aerodynamic forces that need to be overcome by the propulsion force, the effect of this will be assessed in the results section.

To determine the mass using Eq. 9, all sensors and constants should be well calibrated and defined because slight variations in the force balance between terms in the numerator and denominator can cause severe variance in the estimated mass of the vehicle. Fine calibration of the sensors data and constants, like drag coefficient and rolling resistance, is however quite difficult to perform theoretically or by simulation, so these parameters were calibrated based on test results. An iterative method was used to perform fine calibration of the sensors such that the mass equation yields the known masses for the vehicle rig in different loading conditions and for different routes travelled.

To gather data, the vehicle 20 was fitted with the Arduino sensor board 80 to stream the various parameters to the laptop. Normal driving routes on public roads were driven as a normal driver would do, so that realistic trip data may be obtained. The data stream was paused when the vehicle brakes were applied, due to the difficulties mentioned above, thus simply neglecting when the brakes influence the vehicle's movement.

### Results

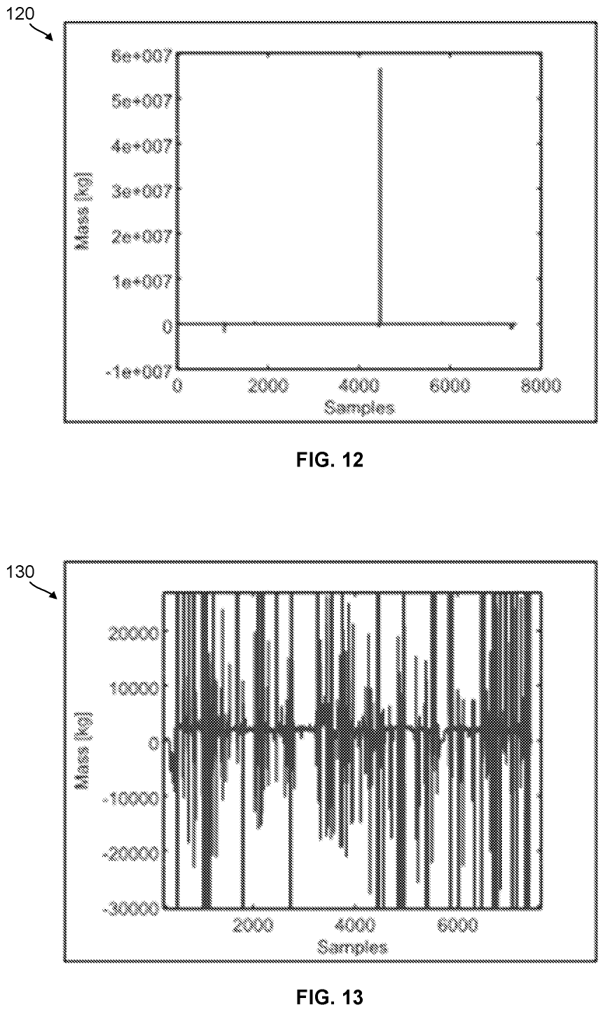

FIG. 12 shows a graph 120 of raw mass estimation derived from Eq. 9 for a route of +20 km travelled. This is the data before imposing any limits or cutting/discarding of data. FIG. 13 shows a zoomed-in version 130 of FIG. 12.

From the data shown in FIGS. 12-13, it can be seen that the mass results obtained by implementing Eq. 9 yields non-stable and completely unrealistic results. The vehicle had an unloaded mass of 2,090 kg with a full tank of fuel and no driver, so this is the typical order of magnitude where the mass estimations are expected. The mass estimation equation is very sensitive when the forces are very small, and any noise/variation in any of the parameters can potentially yield these unrealistic results. To avoid such unrealistic mass estimates, a strategy needs to be implemented to filter out the unrealistic data or avoid using the scenarios where such data are expected to occur. To find the sources of unrealistic data the mass was plotted as a function of various measured parameters.

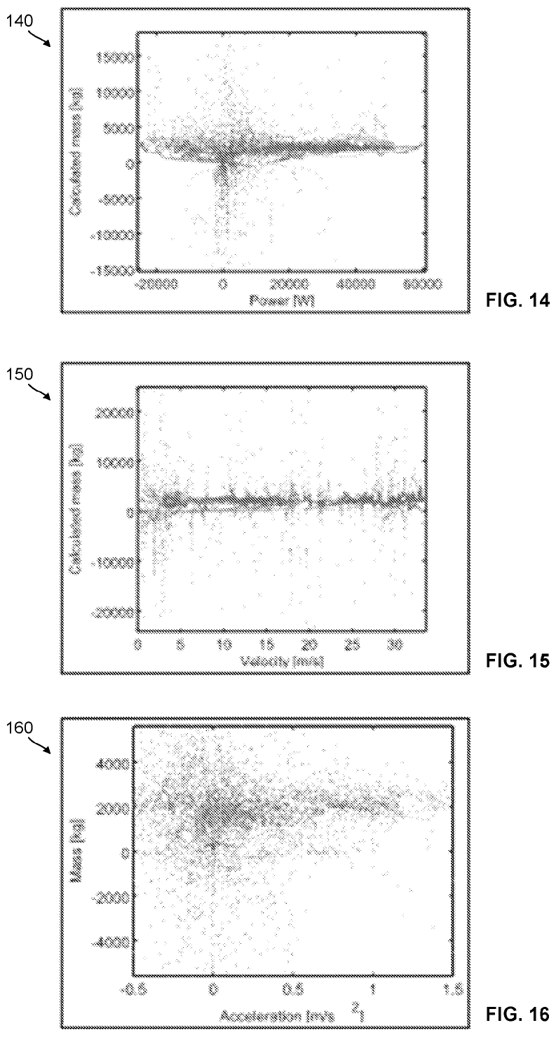

FIGS. 14-16 show graphs 140-160 of the calculated mass plotted as a function of: wheel power (140), velocity (50), acceleration (160). From these figures, regions may be identified where the most stable data is found, and the unrealistic areas can then be avoided/discarded. It is noted that the calculated mass has large errors at low power levels and seems less noisy at absolute power levels greater than 20 KW (FIG. 14).

Power is calculated by taking the product of propulsion force and velocity P=F.V. There do not seem to be any assumptions that can be made for the data as a function of velocity (FIG. 15). FIG. 16 shows that higher accelerations yield more stable results, except for cases where the acceleration was calculated in the discontinuous sections experienced when pausing the data stream during braking and calculating the acceleration based on discontinuous velocity data, so data points for unachievable acceleration are also neglected (acceleration >3 m/s² discarded).

A first strategy implemented was to remove data that did not meet a minimum amount of absolute wheel power, thus discarding the very low velocity conditions as well as coasting, where the terms in the mass equation become small and any variation in any parameter causes vast changes and instability, and thus errors in the mass calculated. This will also remove data when the vehicle is stationary and most of the terms in Eq. 9 fall away.

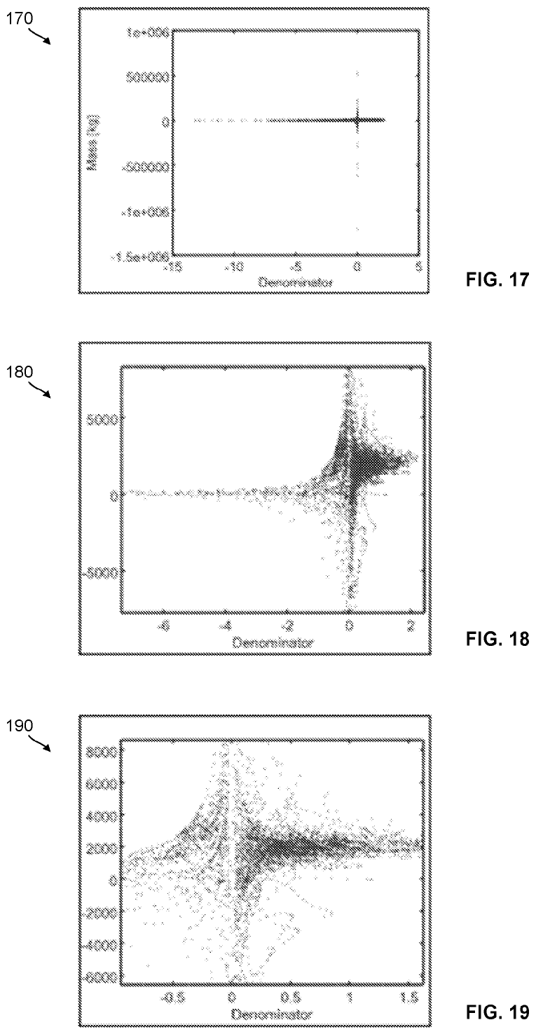

From the data shown in FIGS. 17-19, which shows various graphs 170-190 having different denominator vs mass axes based on EP. 9. It may be noted that as the denominator in Eq. 9 approaches zero, the calculated mass shoots out of reasonable bounds. A negative denominator yields mass results close to zero, which is also not applicable. The second strategy to remove unrealistic results was to then limit the minimum size of the denominator and impose a maximum on the absolute value of the estimated mass that may be considered for further steps.

A suitable denominator minimum was determined through simulations using actual test data to be 0.2. This was set at a point where the final result was not very sensitive to changes in this value. Making it too small yields mass estimates that shoot up too high and making it too large discards a lot of usable data. The test vehicle had a nominal mass of 2,090 kg, so setting of the mass cut-off needs to be at a value significantly higher than the true mass so that the cut-off would not end up discarding usable data that a low pass filter strategy would be able to use sensibly. The mass cut-off value for the absolute value of the calculated mass was set at 10,000 kg. This value was found to be small enough to filter out the extreme data, but large enough to not cut off usable data that can be filtered in another step. It was also found that small changes in this mass cut-off value did not influence the estimated mass significantly. This is important so as to make sure that the value did not yield a satisfactory result by accident.

Negative mass estimates were not directly discarded as it was noted that strong lows would often have counteracting strong highs to the other end, yielding on average an acceptable result. This was done to not overly limit the results and overwhelming the freedom of calculation by too strict pre-conceived bounds. It may not help limiting the values so much that the answer is almost pre-generated and fixed, independent of the data gathered, rather than determined by well-considered measurements, especially with data that has such a wide range of results.

From the simulations performed, it makes sense why so much data was discarded. Using only maximum power data is not ideal though, as a vehicle does not necessarily see full power during every run and maximum power would potentially negatively impact vehicle efficiency, which is against the whole goal of an optimisation project. With the proposed parameters to cut the unrealistic mass values, the strategy proposed also excludes close to 75% of the data points.

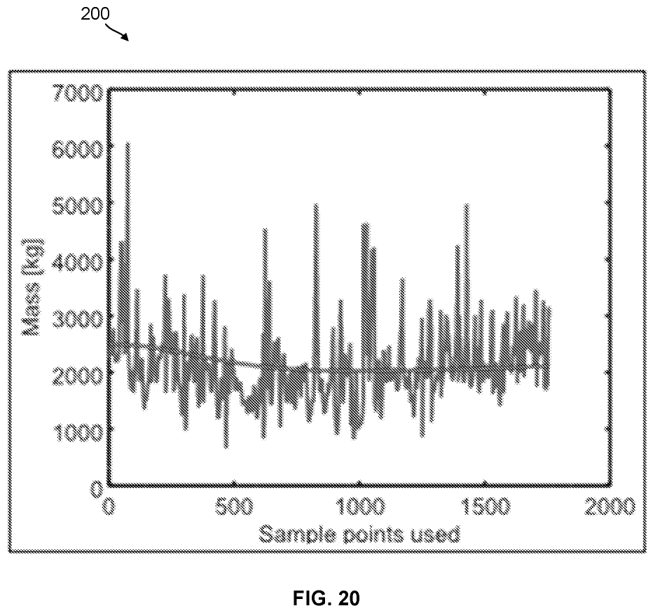

FIG. 20 shows a graph 200 of the selected mass estimate data based on the above threshold parameters (the erratic line) with the continuously updating mean of the mass values (the smoother line). It can be noted that, when there are fewer data points available the mass value can vary quickly as the selected mass values are streamed in, but as the number of available data points goes up the mean value for the mass stabilises at the desired true mass value. The answer for this test run was spot on to the estimated real mass of the vehicle. The tests contained a combination of highway and urban driving, with the middle section of FIG. 20 being the highway part from around point 500 until point 1200. It is observed that highway driving does in some instances yield slightly lower mass averages than urban driving.

Once data is generated for the mass, it may be necessary to do fine calibration and characterisation of all the parameters to ensure the results reported are usable and accurate. These may include torque cell and drag coefficient calibration, coefficient of rolling resistance characterisation, and finding the best values for the boundary parameters: power cut, mass cut, and minimum allowable denominator. Over 2,000 simulations were performed to iteratively find the values for these parameters that best fit the true data. These values are summarised in table 1.

TABLE 1

| Parameter | Value | Unit |
|---|---|---|
| Torque calibration factor | 1.04 | — |
| Wheel radius (235/85R16) | 0.39 | Meter |
| Drag coefficient | 0.41 | — |
| Frontal area | 2.33 (vehicle, vehicle with | m² |
| | small trailer) | |
| | 3.3 (vehicle with large trailer) | |
| Rolling resistance | 0.0129 (1 + Velocity/36) | — |
| Mass threshold | 10000 | kg |
| Minimum power | 20000 | kw |
| Denominator minimum | 0.2 | — |

Table 2 summarises the test results for a number of road tests (27) showing the actual mass of the vehicle during the test, the mass estimated by the mass estimation strategy for that specific test and the error in the estimated value compared to the correct value. Test 26 and 27 have their simulation results presented twice, part “a” shows the estimated mass when the frontal area is left as the vehicle frontal area, as with the other simulations, where part “b” accounts for the increased frontal area of the large trailer 110, as was shown in FIG. 11.

TABLE 2

| Test | | True | Estimated | Error |
|---|---|---|---|---|
| # | Payload | mass | mass | % |
| 1 | Driver + Fuel | 2150 | 2049.9 | 4.66 |
| 2 | Driver + Fuel | 2140 | 2326.9 | −8.73 |
| 3 | Driver + Fuel | 2120 | 1974.7 | 6.85 |
| 4 | Driver + Fuel | 2115 | 2115.9 | −0.04 |
| 5 | Driver + Fuel | 2150 | 1949.2 | 9.34 |
| 6 | Driver + Fuel | 2140 | 2178.5 | −1.80 |
| 7 | Driver + Fuel | 2150 | 2239.7 | −4.17 |
| 8 | Driver + Fuel | 2140 | 2221 | −3.79 |
| 9 | Driver + Fuel | 2140 | 2242.3 | −4.78 |
| 10 | Driver + Fuel | 2135 | 2204.8 | −3.27 |
| 11 | Driver + Fuel | 2125 | 1954.3 | 8.03 |
| 12 | Driver + Fuel | 2120 | 2095.6 | 1.15 |
| 13 | Driver + Fuel | 2115 | 2152.6 | −1.78 |
| 14 | Driver + Fuel | 2112 | 2115.5 | −0.17 |
| 15 | Driver + Fuel | 2130 | 2053.5 | 3.59 |
| 16 | Driver + Fuel | 2135 | 1982.2 | 7.16 |
| 17 | Driver + Fuel | 2145 | 1997.5 | 6.88 |
| 18 | Driver + Fuel + 330 kg water | 2430 | 2534.7 | −4.31 |
| 19 | Driver + Fuel + 330 kg water | 2430 | 2291 | 5.72 |
| 20 | Driver + Fuel + 330 kg water | 2425 | 2658.3 | −9.62 |
| 21 | Driver + Fuel + 330 kg water | 2420 | 2265.7 | 6.38 |
| 22 | Driver + Fuel + 330 kg water | 2490 | 2365.8 | 4.99 |
| 23 | Driver + Fuel + small trailer + | 2745 | 2869.6 | −4.54 |
| | 375 kg water | | | |
| 24 | Driver + Fuel + small trailer + | 2735 | 2758.3 | −0.85 |
| | 375 kg water | | | |
| 25 | Driver + Fuel + small trailer + | 2730 | 2782 | −1.90 |
| | 375 kg water | | | |
| 26a | Driver + Fuel + large trailer | 2825 | 2992.6 | −5.93 |
| 27a | Driver + Fuel + large trailer + | 3270 | 3375.4 | −3.22 |
| | 445 kg water | | | |
| 26b | Driver + Fuel + large trailer | 2825 | 2840.1 | −0.53 |
| | (Improved frontal area) | | | |
| 27b | Driver + Fuel + large trailer + | 3270 | 3246 | 0.73 |
| | 445 kg water (Improved frontal area) | | | |

A standard deviation for the error in the data presented in Table 2 is 5.2%. This includes an inside-vehicle payload variance of 330 kg (˜15% change) and adding of a small or large trailer to the vehicle equating to up to 52% Gross Combined Mass (GCM) change.

### CONCLUSION

A model was proposed that makes use of a force balance equation using Newton's second law of motion and implemented sensors to obtain an estimate for a vehicle's total (gross combined) mass. Knowledge of mass value is desirable so as to facilitate proper optimising of the energy usage of a hybrid vehicle during operation.

Simple sensing devices were implemented to gather the required information on vehicle forces and incline of the route being travelled. With these parameters known, a program can be executed that estimated the vehicle's mass. Due to the difficulty in obtaining an accurate braking force value from the simple sensing data, it was decided to simply exclude data when the brakes are applied.

The initial estimates for the vehicle mass yielded completely unrealistic values, which led to the implementation of a data filtering strategy that only used data when it fell within parameters determined to yield the most likely accurate mass estimates. In other words, the control module may be configured to filter signals from the sensors such that the signals are only used when they fall within predefined parameters. This may involve setting a minimum amount of wheel power, setting an upper limit to the mass usable and setting a minimum denominator size in the mass estimation equation. With the mass estimates now in reasonable bounds simulations were run to obtain accurate calibration for the torque load cell, the drag force, and an empirical equation for the rolling resistance as a function of vehicle velocity. It was found that the mass estimation may be sensitive to wind, which can be accounted for more accurately by implementing a wind speed sensor on the vehicle.

Rather noisy real-time mass estimates were still found, but it was found that averaging of the mass estimations yielded an estimate for the vehicle mass that was accurate to within 5.2% on average of the actual mass of the vehicle (and trailer if present). It was found in general that estimation of the mass yielded accurate results when more than 500 usable data points were evaluated. This is equivalent to around 5 minutes of driving. The ability to estimate the gross combined mass of a hybrid vehicle accurately will allow the hybrid control system to make better decisions on energy usage estimations, thus further improving the overall fuel consumption of the vehicle, reducing cost and emissions.

1. A system for estimating a mass of a vehicle, the system including:
a torsion sensor provided on at least a drive axle of the vehicle, wherein the torsion sensor is configured to measure torsion in the drive axle between a drive input and a load of the drive axle;
at least one speed sensor configured to measure a speed of the drive axle or of the vehicle;
at least one sensor configured to measure or derive an inclination of the vehicle; and
a control module which is:
communicatively coupled to the torsion sensor, the speed sensor, and the sensor to measure or derive the inclination, thereby to receive signals from the sensors indicative of the characteristics they measure; and
configured to estimate the mass of the vehicle based on the signals from the sensors by solving an equation of motion based on the received signals.

2. The system as claimed in claim 1, in which the torsion sensor is embodied by a plurality of strain gauges.

3. The system as claimed in claim 2, in which the strain gauges are provided at various locations on the drive axle.

4. The system as claimed in claim 3, in which the strain gauges are provided at locations on a front and a rear of the drive axle.

5. The system as claimed in claim 4, in which the locations on the front and the rear are mirrored.

6. The system as claimed in claim 4, in which the locations on the front and the rear allow the strain gauges to be wired such that bending moments in a forward and backward direction are cancelled out.

7. The system as claimed in claim 2, in which the strain gauges are placed on a horizontal centreline of the drive axle such that they will not see a bending moment due to supporting a stationary weight of the vehicle.

8. The system as claimed in claim 2, in which there are eight strain gauges on the drive axle, with two at a front left, two at a front right, two at a rear left, and two at a rear right of the drive axle.

9. The system as claimed in claim 2, in which the strain gauges are interconnected in a Wheatstone bridge configuration.

10. The system as claimed in claim 2, in which:
the drive axle is a live axle supported on a suspension at ends of the axle by means of leaf springs; and
torque transfer from differential to wheel is measured by the strain gauges as a reaction force of the centrepiece of the differential relative to the suspension.

11. The system as claimed in claim 1, in which the speed sensor is provided by one or more of:
an optical encoder coupled to a rotary part of the vehicle; or
standard equipment on the vehicle, or a connection to an ECU (Electronic Control Unit) of the vehicle, or by a GPS module.

12. The system as claimed in claim 1, in which:
the sensor to measure or derive an inclination includes a barometric pressure sensor;
the barometric pressure sensor is configured to measure barometric altitude; and
the control module is configured to determine barometric altitude as a function of distance thereby to provide an estimation for an incline of a section of travel.

13. The system as claimed in claim 1, in which the control module includes preconfigured or preconfigurable constants for use in the equation of motion, including a drag coefficient for the vehicle to estimate drag or aerodynamic resistance of the vehicle.

14. The system as claimed in claim 1, in which the equation of motion is a force-balance equation which includes, for a vehicle travelling on an incline, propulsion force, aerodynamic resistance, rolling resistance, acceleration, and incline forces, wherein a sum of forces balance is performed to solve for the mass of the vehicle, with the other variables being measured, estimated, known, or predefined.

15. The system as claimed in claim 1, in which the control module is configured to filter the signals from the sensors, such that the signals are only used when they are within predefined parameters.

16. A method of estimating a mass of a vehicle, the method including:
measuring, by a torsion sensor provided on at least a drive axle of the vehicle, torsion in the drive axle between a drive input and a load of the drive axle;
measuring, by at least one speed sensor, a speed of the drive axle or of the vehicle;
measuring or deriving, by at least one sensor, an inclination of the vehicle; and
estimating, by a control module which is communicatively coupled to the torsion sensor, the speed sensor, and the sensor to measure or derive the inclination thereby to receive signals from the sensors indicative of the characteristics they measure, the mass of the vehicle based on the signals from the sensors by solving an equation of motion.

17. The method as claimed in claim 16, which includes:
estimating the mass of the vehicle;
comparing the estimation with known quantities (e.g., a pre-measured or reference mass of the vehicle); and
adjusting constants or criteria of the control module based on the comparison, thereby to tune the estimation.

18. The method as claimed in claim 17, in which at least one step is repeated iteratively to tune the estimation further.
